(19) United States
(12) Patent Application Publication
(10) Pub. No.: US 2014/0129580 A1
(43) Pub. Date: May 8, 2014

(54) METHOD AND A DEVICE FOR PROMPTING WEBPAGE ADDRESS

(71) Applicant: Tencent Technology (Shenzhen) Company Limited, Shenzhen (CN)

(72) Inventors: Jinghui XIAO, Shenzhen (CN); Yuguo LIU, Shenzhen (CN); Tiange SI, Shenzhen (CN); Xiaobo ZHOU, Shenzhen (CN)

(73) Assignee: Tencent Technology (Shenzhen) Company Limited, Shenzhen (CN)

(21) Appl. No.: 14/152,391

(22) Filed: Jan. 10, 2014

Related U.S. Application Data
(63) Continuation of application No. PCT/CN2013/082429, filed on Aug. 28, 2013.

(30) Foreign Application Priority Data
Oct. 11, 2012 (CN) 201210384597.5

(51) Int. Cl. G06F 17/30

(52) U.S. Cl. CPC G06F 17/30386
USPC 707/758

(57) ABSTRACT

The present invention relates to a webpage address prompting method, including: reading entered content of an address bar; searching according to a preset matching rule for a plurality of webpage addresses which match the entered content from a stored webpage addresses collection; sequencing the plurality of webpage addresses which match the entered content according to a sequencing rule; and displaying at least one forefront webpage address from among the sequenced plurality of webpage addresses as a candidate webpage address. The present invention also relates to a webpage address prompting device which enables a user to visit a target webpage address in a rapid and accurate way with minimal entered content in the address bar of web browser software.

### CROSS-REFERENCE TO RELATED APPLICATIONS

The present application is a continuation application out of PCT Application No. PCT/CN2013/082429, filed on Aug. 28, 2013, which claims priority to Chinese Patent Application No. 201210384597.5, filed on Oct. 11, 2012, the entireties of both of which are incorporated by reference.

### FIELD OF THE TECHNOLOGY

The present application relates to the field of webpage browsing technology, and more particularly a method and a device for prompting webpage address.

### BACKGROUND

Along with development of the Internet, browser software, as computer users' access to the Internet, has been given increasing attention by Internet enterprises. The early browser software had rendering and presenting website pages as primary functions. The later browser software further provided a variety of customizable plug-ins and integration with search engines. Meanwhile, some of the current browser software has begun to provide personalized and customized services to reduce users' operation time, shorten users' distance from the Internet and improve users' surfing experience.

The address bar is an important component of the browser software. After a user enters a webpage address in the address bar of the browser software, the browser software will render and present the corresponding webpage content. When the user enters content in the address bar, some of the current browser software will automatically prompt a plurality of candidate webpage addresses for the user's selection, so as to reduce the user's operation time and accelerate the web surfing speed. However, if the browser software's webpage address prompt method is poor, it will present some webpage addresses purely of an advertising nature that do not conform to the user's basic needs, and the user will be unable to find the target webpage address in a rapid and efficient way with minimum entry, thus slowing down the webpage visit speed.

### SUMMARY

In view of the foregoing, it is necessary to provide a webpage address prompt method and device that can prompt candidate webpage addresses containing the target webpage address according to the content entered by the user in the browser software, so as to enable the user to visit the target webpage address in a rapid and accurate way with minimum entry in the browser software, featuring efficiency, simplicity and intelligence.

A webpage address prompt method, comprising: read the content entered in the address bar; search for the webpage addresses matching the entered content from the stored webpage address collection in accordance with the preset matching rule; sequence the webpage addresses matching the entered content in accordance with the preset sequencing rule; and display at least the first one webpage address among the sequenced webpage addresses as a candidate webpage address.

A webpage address prompt device, comprising: a reading module for reading the content entered in the address bar; a matching module for searching for the webpage addresses matching the entered content from the stored webpage address collection in accordance with the preset matching rule; a sequencing module for sequencing the webpage addresses matching the entered content in accordance with the preset sequencing rule; and a prompt module for displaying at least the first one webpage address among the sequenced webpage addresses as a candidate webpage address.

The said webpage address prompt method and device enable the user to visit the target webpage address in a rapid and accurate way with minimum entry in the browser software, featuring efficiency, simplicity and intelligence. Furthermore, the entire matching and sequencing process is rule-based, and the control of the matching and sequencing results can be conveniently realized by rule modification.

### BRIEF DESCRIPTION OF THE DRAWINGS

The accompanying drawings are included to provide a further understanding of the claims and disclosure, are incorporated in, and constitute a part of this specification. The detailed description and illustrated embodiments described serve to explain the principles defined by the claims.

FIG. 1 is a flow chart illustrating an exemplary webpage address prompting method, according to an embodiment of the invention.

FIG. 2 is an exemplary schematic diagram of the webpage address prompting method, according to an embodiment of the invention.

FIG. 3 is an exemplary structural block diagram of a webpage address prompting device, according to an embodiment of the invention.

### DETAILED DESCRIPTION OF THE EMBODIMENTS

The various embodiments of the present invention are further described in details in combination with attached drawings and embodiments below. It should be understood that the specific embodiments described here are used only to explain the present invention, and are not used to limit the present invention.

Figure is a flow chart illustrating an exemplary webpage address prompting method, according to an embodiment of the invention. The webpage address prompting method may include the following exemplary steps:

Step S110: Read content in an address bar of web browser software entered by a user.

The content may be entered through typing a keypad or a touch screen key pad of a prompting device, such as a mobile terminal or any device connected to an internet service. The entered content may be displayed on an address bar portion of a display, which the entered content interacts with the web browser software of the prompting device. Every keystroke input by the user is monitored and acquired as entered content by the web browser software, and is utilized for searching for a target webpage address.

Step S120: Search according to a preset matching rule for a plurality of webpage addresses which may match the entered content in a stored webpage address collection.

More specifically, the stored webpage address collection may include webpage addresses of at least the following three types: webpage history addresses from web browser software, favorite webpage addresses added by the web browser software, and authority websites webpage addresses.

The authority websites are referred to websites which are well-known or well recognized to be reliable, accurate, unbiased and responsible in their released media content. Therefore, these websites are regarded as authority websites and are frequently visited by a large number of users for information source. Alternately, the authority websites may be highly popular because of their on-line services, search engine capabilities, or high entertaining values. Some of these authority websites may be sina.com, baidu.com, yahoo.com, cnn.com, google.com, bbc.com, and youtube.com, to name a few. The webpage addresses of the authority websites may be obtained at a server end by mass data statistics.

The webpage history addresses and the favorite webpage addresses may be retrieved from within the prompting device by the web browser software. More specifically, the webpage history addresses and the favorite webpage addresses reflect the user's web browsing habits, user's personal preferences and history of websites visit frequency. Such webpage history addresses and the favorite webpage addresses information may be stored into a cache memory for speedy retrieval and launching.

On the other hand, the authority websites webpage addresses reflect certain prior knowledge and prevailing trends among the users. Accordingly, webpage addresses stored in the webpage address collection may be utilized to prompt a user by pointing to a target webpage address upon with minimal entered content to the address bar with great accuracy and speed.

The matching rule may be used to define how to search for the webpage addresses by matching the entered content in the address bar to the webpage address (i.e., URL) collection. For example, a webpage address such as a URL of http://news.sina.com.cn/c/2012-09-18/221725201909.shtml may be very long and may include: one-level or multilevel subdirectories, and a file name in addition to a main domain name. Therefore, it is understandable that different parts within a domain name may function differently in matching to the address the user truly wants to enter. Besides, users seldom enter the sub-directory or the specific file name.

In most cases, users only enter the main domain name and the second-level domain name. As seen from the above URL (i.e., http://news.sina.com.cn/c/2012-09-18/221725201909.shtml) as an example, the entered content by the user may contain only “news” or “sina”. In view of this, the matching rule may specify that in matching URLs, only the content of the main domain name and second-level domain name in the URL should be searched. In some URLs, a second-level directory however, is adopted to distinguish from the webpage contents, such as “sports” in the URL http://www.domain.com/sports belongs to a second-level directory, which is also valuable to the URL matching. Therefore, the matching rule should specify that the content of the second-level directory be searched also.

The above mentioned matching rule may be stored either in the prompting device locally (i.e., the mobile terminal, tablet device, computer, laptop computer, etc.) or remotely in a cloud server. Alternately, the matching rule may be stored in the prompting device locally but synchronized with the cloud server periodically. In terms of specific storage mode, the matching rule may be stored in a database or stored directly as a file locally or remotely in the cloud server.

Step S130: Sequence the plurality of webpage addresses which match the entered content according to a sequencing rule.

The collection of the URLs or webpage addresses matching the entered content is initially acquired in Step S120. For example, when “s” is entered as the content in the address bar, “s” may be matched to a number of possible webpage addresses, which may include http://www.sina.com.cn, http://www.sohu.com, http://www.soso.com, http://blog.sina.com.cn, http://video.sina.com.cn and http://www.sogou.com. These matched URLs may be sequenced in order to conform to user's expectation as much as possible. The sequencing rule may be used to define how to sequence the plurality of matched webpage addresses.

The sequencing rule may implement the following exemplary rules:

Rule 1: Webpage history addresses may have a higher priority than that of the favorite webpage addresses. The favorite webpage addresses may have a higher priority than that of the authority websites webpage addresses, and the webpage addresses with a higher priority may be sequenced in front of those with lower priority. In addition, URLs of webpage history in user's local prompting device may have a higher priority over that of the other two URL collections (i.e., favorite webpage addresses and authority websites webpage addresses). URLs of the favorite webpage addresses in user's local prompting device may have a higher priority over that of the URL collection of authority websites.

Rule 2: Of the historical URLs of the user's local prompting device, assuming the prerequisite of hitting the user's entered content has been met: the user's time of more recent visit is the only sequencing standard of the URLs. In other words, the more recent the time of website visit is, the more important the URL is, otherwise, the URL has less importance.

Rule 3: Of the URLs in the favorite webpage addresses, assuming that the prerequisite of hitting the user's entered content has been met: the more recent time when a URL is added to the favorites by the user is the only sequencing standard. In other words, the more recent the user's addition of the favorite URL is, the more important the webpage address is, otherwise, the URL has less importance.

Rule 4: Of the URLs of authority websites, assuming that the prerequisite of hitting the user's entered content has been met: the website authority is the only sequencing standard. In other words, the more authoritative the website is, the more important the corresponding URL is, otherwise, the URL has less importance. The authority of a website is decided by the manual scoring of poll professionals.

According to the above rules, the matched history URLs, URLs in the favorites and the URLs of authority websites are first sequenced in accordance with Rules 2, 3 and 4, and then the three types of webpage addresses are combined in accordance with Rule 1.

The sequencing rule may be stored either in the local prompting device or remotely in a cloud server, or stored in the local prompting device but synchronized with the remote cloud server periodically. In terms of specific storage mode, the sequencing rule may be stored in a database or locally stored directly as a file.

Step S140: Select and display at least one forefront first webpage address from among the sequenced plurality of webpage addresses as a candidate webpage address.

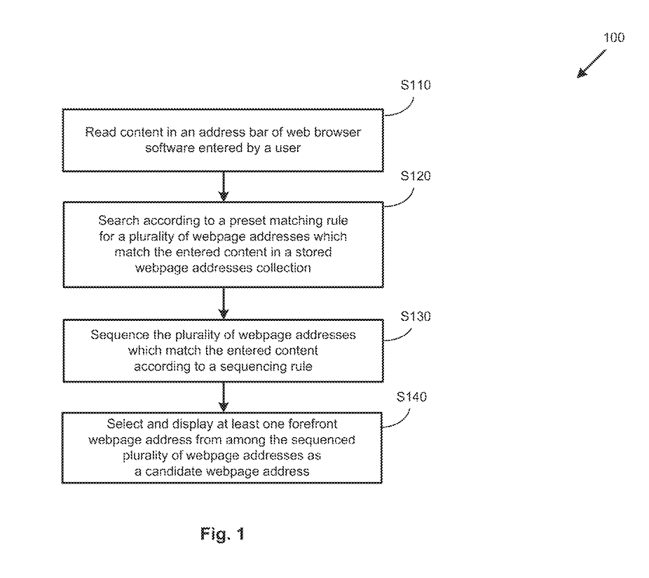

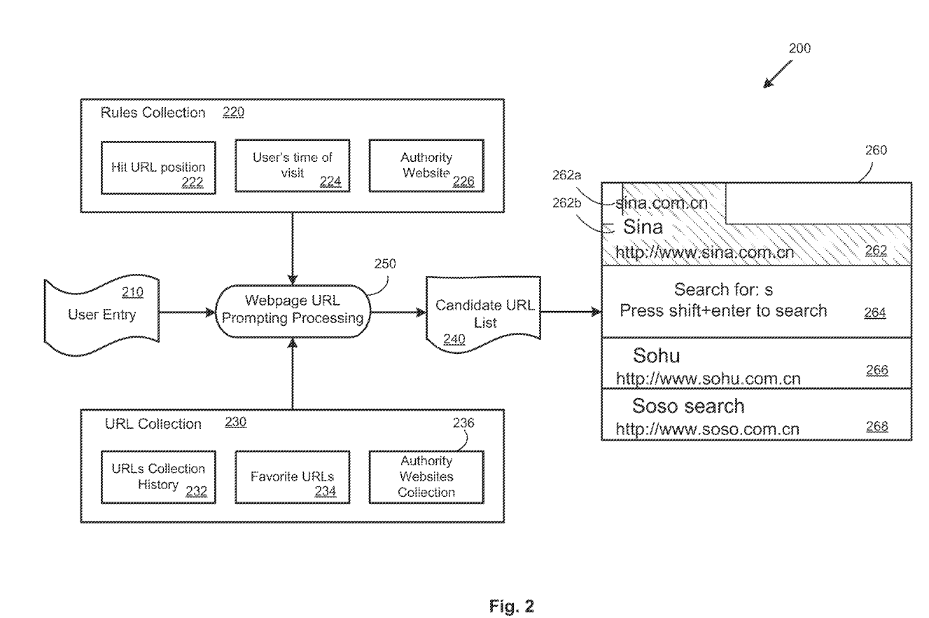

The sequencing rule in Step S130 therefore results in the following order: http://www.sina.com.cn, http://www.sohu.com, http://www.soso.com, http://blog.sina.com.cn, http://video.sina.com.cn and http://www.sogou.com. More specifically, FIG. 2 illustrates an exemplary display of three matched results (262, 266 and 268) out of the above six matched results as described in Step S130 in FIG. 1.

FIG. 2 is an exemplary schematic diagram of the webpage address prompting method, according to an embodiment of the invention.

A user entry (210) may be entered as content at an address bar of a prompting device. The web browser software executed by a processor performs webpage URL prompting processing (250). The entered content from the user entry (210) is compared for a plurality of matched URLs from a URL webpage collection (locally or remotely). If a match is found, a priority is set on the matched URLs according to the matching rules (220) as described in step S120. Sequencing rules (222, 224, and 226) are applied to sequence the matched URLs to generate a candidate list (240), and subsequently displayed on the prompting device display (260).

In this embodiment, when the user key in “s” on the prompting device, the webpage URL prompting processing would display a plurality of matched URL results (262, 266, 268), which the matched result (262) is sequenced as the forefront candidate based on applying the matching rule and the sequencing rule.

It is understandable that the number of the matched webpage addresses to be displayed may be set or directly designated by the user. It is also understandable that the said matching rule and sequencing rule may also be modified, i.e. the webpage address prompt method of this embodiment may further include: modifying the matching rule or sequencing rule according to a user's setting or modified at the cloud server end to control the final display result.

The webpage address prompting method illustrated in this embodiment enables the user to visit the target webpage address in a rapid and accurate way with minimum content entry in the browser software, thus featuring efficiency, simplicity and intelligently. Furthermore, the entire matching and sequencing process is rule-based, and the control of the matching and sequencing results may be conveniently realized by rules modification.

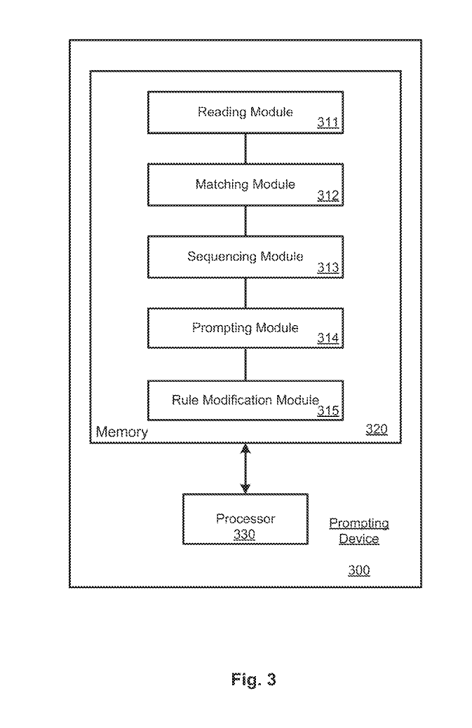

FIG. 3 is an exemplary structural block diagram of a webpage address prompting device (300), according to an embodiment of the invention.

The webpage address prompting device (300). The webpage address prompting device (300) may be a smart phone, a mobile terminal, a wireless tablet device, a computer, a laptop computer, or any device that may be connected to an internet. The webpage address prompting device (300) may include at least a processor (330) executing codes of a web browser software stored in a memory (320). The memory may be a combination of memory modules such as a ROM, a DRAM, or cache memory. The processor (330) may execute a plurality of modules, namely, a reading module (311), a matching module (312), a sequencing module (313), a prompting module (314) and a rule modification module (315).

It is understandable that the various modules may be referred as computer programs, codes or program segments for executing one or a plurality of special functions. The various modules may also be executed as a plug in. Any separation of the above modules (311-315) should not be construed as separation the actual program codes must also be separated.

The reading module (311) may read the content entered in the address bar. The matching module (312) may search for the webpage addresses matching the entered content from the stored webpage address collection in accordance with the preset matching rule. The sequencing module (313) may sequence the webpage addresses matching the entered content in accordance with the preset sequencing rule; and the prompt module (314) may display at least one forefront webpage address among the plurality of sequenced webpage addresses as a candidate webpage address.

In addition, the webpage address prompt device (300) may further include a rule modification module (315), which may be used to modify the matching rule and the sequencing rule according to the user's setting or an update at the remote cloud server end. For example, the user may adjust the order of the matching rule and the sequencing rule.

As illustrated in FIG. 2, the webpage address prompt device (300) of this embodiment enables the user to visit the target webpage address in a rapid and accurate way with minimum content entry in the browser software, featuring efficiency, simplicity and intelligence. Further, the entire matching and sequencing process is rule-based, and the control of the matching and sequencing results may be conveniently realized by rule modification.

In addition, this embodiment of the present invention also provides a non-transitory computer-readable storage medium with computer-executable commands stored within. For example, the invention may be implemented as an algorithm as codes stored in a program module or a system with multi-program-modules. The said computer-readable storage medium may be, for example, nonvolatile memory such as compact disc, hard drive or flash memory. The said computer-executable commands are used to enable a computer or similar computing device to accomplish the operations of the above webpage address prompt method.

The foregoing represents only some preferred embodiments of the present invention and their disclosure cannot be construed to limit the present invention in any way. Those of ordinary skill in the art will recognize that equivalent embodiments may be created via slight alterations and modifications using the technical content disclosed above without departing from the scope of the technical solution of the present invention, and such summary alterations, equivalent changes and modifications of the foregoing embodiments are to be viewed as being within the scope of the technical solution of the present invention.

It will be apparent to those skilled in the art that various modifications and variations can be made to the present disclosure without departing from the scope or spirit of the disclosure. In view of the foregoing, it is intended that the present disclosure cover modifications and variations of this disclosure provided they fall within the scope of the following claims and their equivalents.

What is claimed is:

1. A webpage address prompting method, comprising:
reading entered content of an address bar;
searching according to a preset matching rule for a plurality of webpage addresses which match the entered content from a stored webpage addresses collection;
sequencing the plurality of webpage addresses which match the entered content according to a sequencing rule; and
displaying at least one forefront webpage address from among the sequenced plurality of webpage addresses as a candidate webpage address.

2. The webpage address prompting method according to claim 1, wherein the stored webpage address collection comprises webpage addresses of at least following three types: webpage history addresses from web browser software, favorite webpage addresses added by the web browser software, and authority websites webpage addresses.

3. The webpage address prompting method according to claim 2, wherein the sequencing rule specifies that webpage history addresses has a higher priority than that of the favorite webpage addresses, the favorite webpage addresses has a higher priority than that of the authority websites webpage addresses, and the webpage addresses with a higher priority are sequenced in front of those with lower priority.

4. The webpage address prompting method according to claim 3, wherein the sequencing rule is based on:
a more recently visited webpage history address has a priority over a less recently visited webpage history address;
a more recently visited favorite webpage address has a priority over a less recently visited favorite webpage address; and
a more recognized authority website webpage address has a priority over a less recognized authority website webpage address.

5. The webpage address prompting method according to claim 1, wherein the preset matching rule specifies that a match is found, if the entered content matches to anyone of: main domain names, second-level domain names or a second-level directory of the main domain names which belong to a stored webpage address in the webpage addresses collection.

6. The webpage address prompting method according to claim 1, comprising:
modifying the preset matching rule or the sequencing rule according to a user's setting.

7. A webpage address prompting device, comprises:
a reading module for reading entered content in an address bar;
a matching module for searching for a plurality of webpage addresses matching the entered content from a stored webpage addresses collection according to a preset matching rule;
a sequencing module for sequencing the plurality of webpage addresses matching the entered content according to a sequencing rule; and
a prompting module for displaying at least one forefront webpage address from among the sequenced plurality of webpage addresses as a candidate webpage address.

8. The webpage address prompting device according to claim 7, wherein the stored webpage address collection comprises webpage addresses of at least following three types: webpage history addresses from web browser software, favorite webpage addresses added by the web browser software, and authority websites webpage addresses.

9. The webpage address prompting device according to claim 8, wherein the sequencing rule specifies that webpage history addresses has a higher priority than that of the favorite webpage addresses, the favorite webpage addresses has a higher priority than that of the authority websites webpage addresses, and the webpage addresses with a higher priority are sequenced in front of those with lower priority.

10. The webpage address prompting device according to claim 9, wherein the sequencing rule is based on:
a more recently visited webpage history address has a priority over a less recently visited webpage history address;
a more recently visited favorite webpage address has a priority over a less recently visited favorite webpage address; and
a more recognized authority website webpage address has a priority over a less recognized authority website webpage address.

11. The webpage address prompting device according to claim 7 wherein the preset matching rule specifies that a match is found, if the entered content matches to anyone of: main domain names, second-level domain names or a second-level directory of the main domain names which belong to a stored webpage address in the webpage addresses collection.

12. The webpage address prompting device according to claim 7, comprises a rule modification module for modifying the preset matching rule or the sequencing rule according to a user's setting.

13. A non-transitory computer-readable medium having stored thereon, a computer program having at least one code section being executable by a machine for causing the machine to perform steps comprising:
reading entered content of an address bar;
searching according to a preset matching rule for a plurality of webpage addresses which match the entered content from a stored webpage addresses collection;
sequencing the plurality of webpage addresses which match the entered content according to a sequencing rule; and
displaying at least one forefront webpage address from among the sequenced plurality of webpage addresses as a candidate webpage address.

14. The non-transitory computer-readable medium according to claim 13, wherein the stored webpage address collection comprises webpage addresses of at least following three types: webpage history addresses from web browser software, favorite webpage addresses added by the web browser software, and authority websites webpage addresses.

15. The non-transitory computer-readable medium according to claim 14, wherein the sequencing rule specifies that webpage history addresses has a higher priority than that of the favorite webpage addresses, the favorite webpage addresses has a higher priority than that of the authority websites webpage addresses, and the webpage addresses with a higher priority are sequenced in front of those with lower priority.

16. The non-transitory computer-readable medium according to claim 15, wherein the sequencing rule is based on:
a more recently visited webpage history address has a priority over a less recently visited webpage history address;
a more recently visited favorite webpage address has a priority over a less recently visited favorite webpage address; and
a more recognized authority website webpage address has a priority over a less recognized authority website webpage address.

17. The non-transitory computer-readable medium according to claim 13, wherein the preset matching rule specifies that a match is found, if the entered content matches to anyone of: main domain names, second-level domain names or a second-level directory of the main domain names which belong to a stored webpage address in the webpage addresses collection.

18. The non-transitory computer-readable medium according to claim 13, comprising: modifying the preset matching rule or the sequencing rule according to a user's setting.
